(19) United States
(12) Patent Application Publication
(10) Pub. No.: US 2010/0008654 A1
(43) Pub. Date: Jan. 14, 2010

(54) Digital signal conversion system and method, and computer-readable recording medium thereof

(76) Inventor: Yueh-Teng Hsu, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/385,986

(22) Filed: Apr. 27, 2009

(30) Foreign Application Priority Data
Jul. 10, 2008 (CN) 200810029460.1

(51) Int. Cl. H04N 7/01

(52) U.S. Cl. 386/131

(57) ABSTRACT

A digital signal conversion system and method, and a computer-readable recording medium thereof are adapted to perform sampling rate conversion on audio/video digital signals when a multimedia file is played by an electronic device. The digital signal conversion system includes a reading process, a conversion process and a storage process. First, a digital signal data is read by the reading process. Next, a corresponding number of copies are replicated for each bit of the digital signal data according to a digital signal sampling conversion ratio recorded in a sampling rate conversion sequence, so as to convert the sampling of the digital signal data and store the replicated digital signal data into a memory.

### CROSS-REFERENCE TO RELATED APPLICATIONS

This non-provisional application claims priority under 35 U.S.C. §119(a) on Patent Application No(s). 200810029460.1 filed in China P.R.C. on Jul. 10, 2008 the entire contents of which are hereby incorporated by reference.

### BACKGROUND OF THE INVENTION

1. Field of Invention

The present invention relates to a digital signal conversion system and method, and a computer-readable recording medium thereof, and more particularly to a sampling rate conversion system and method applicable to digital signal data.

2. Related Art

With the progress in operational capability of digital products such as cell-phones, personal digital assistants (PDAs), and portable multimedia players (PMPs), these electronic devices may also be used for multimedia audio/video playing in addition to digital communication. The audio/video digital signal processing on an embedded system is a key research point for many electronic product manufacturers, and the performance of a multimedia device must rely on good audio/video digital signal processing. In the audio/video digital signal processing aspects, the user encounters digital signal sources what different sampling rates, and the digital signal sources may be audio or video signals. Therefore, the multimedia device must first unify the sampling rates of the digital signal sources, and then perform sound mixing and playing.

Sampling rate adjustment is critical to audio/video digital signal processing. In addition, a zero-order-hold (ZOH) converter is an important algorithm for sampling rate conversion. FIG. 1 is a flow chart of a conventional ZOH algorithm. In FIG. 1, the processing of audio data is taken as an example. First, in Step 101, the system processes each target sample data to be converted. Next, in Step 102, a phase value of the sample data is increased gradually, and further compared with 2π (Step 103). If the phase value is larger than 2π, a new audio sample data is obtained. At this point, the system subtracts 2π from the phase value (Step 104), and updates the source sample data (Step 105). Afterward, the system replicates the source sample to a target (Step 106). Then, the system determines whether the end of the target data has been reached (Step 107). If the processing on the sample data is not finished. Steps 102 to 106 are repeated until the processing of a unit block (for example, 1024 sample data) is completed.

It is apparent to those skilled in the art that the above method may convert multimedia data with different sampling rates, and then play the multimedia data at one consistent sampling rate (for example, to convert a 16 kHz audio data into one of 44.1 kHz to be played). As an audio conversion method commonly adopted in the current market. This method is capable of increasing/reducing inputting data capacity so as to increasing/reducing the audio sampling rate by adding/deleting the input data stream. The key point is that the number of replications required for each source sample to a target data stream varies with the phase value. That is to say, the ZOH method may continuously calculate phase variations as references for the number of copies to be made. However, as the calculation of phase variations requires plenty of floating-point number operations, it is quite disadvantageous for processors that do not support floating-point number operations. In another aspect, many portable multimedia electronic devices in the market adopt embedded systems with an ARM architecture (i.e. employing an ARM processor as the CPU). However, the current ARM processor does not support floating-point number operations. Therefore, the digital signal sampling rate conversion performed by ZOH via pure software operations may result in an overly-high load on the processor. Thus, for those portable electronic devices capable of playing audios/videos in the market, the ZOH method takes up a significant percentage of system operation resources (the CPU load reaches about 15%) during audio/video sampling rate conversion, and sometimes the system may even suffer from delay in response (when the system resources get busy in simultaneously executing several programs), thus resulting in dissatisfactory performance when using the portable electronic device.

Further, during the design of the above multimedia device, additional hardware elements may be employed to process the digital signal data by means of hardware acceleration, so as to improve the performance of the device. However, this manner may cause an increase in the design and manufacturing costs of the device. Therefore, many multimedia device R&D manufactures intend to improve the digital signal sampling rate conversion algorithm without increasing the hardware cost, so as to enhance the overall performance of the electronic device and reinforce product competitiveness.

### SUMMARY OF THE INVENTION

Accordingly, in order to meet the requirement of performance improvement of the portable electronic device, the present invention is directed to a digital signal conversion system and method. The digital signal conversion system includes a reading means and a conversion means. The reading means is adapted to read a digital signal data. The conversion means is adapted to replicate a corresponding number of copies for the digital signal data according to an audio/video digital signal sampling conversion ratio recorded in a sampling rate conversion sequence, and store the replicated digital signal data into a memory.

The digital signal conversion system is applied so as to convert the audio/video signal sampling rate, and is characterized as employing a sampling rate conversion sequence, so as to record ratios of various audio/video signals at different sampling rates in advance. In order to perform the audio/video sampling conversion on digital signals, the electronic device loaded with the above system is capable of converting signals through replication according to the pre-recorded ratio of various audio/video signals at different sampling rates. The following advantage is achieved. As for each source sample data, since the proportion of the replicated data amount is pre-defined in the sampling rate conversion sequence, a data replication instruction can be directly employed to replicate and store a corresponding number of target data streams into a memory. Compared with the conventional ZOH method, the present invention avoid time wasting with the floating-point operation time for calculating phase variations. In other words, the sampling rate conversion sequence is adopted to directly generate the corresponding target data streams, so as to reduce operation time. Particularly, for processors that do not support floating-point operations, the method of the present invention may greatly enhance the overall operational performance.

Moreover, the digital signal conversion requires a lot of memory movement, especially when the data sampling rate is increased, in which case the amount of processing data is also increased. As a data input/output (I/O) action is needed for moving the data from the processor into a memory, and the I/O action is relatively slow in the whole operation of the processor, the processing speed will be accelerated if the number of the I/O actions is reduced. Therefore, in practice, the present invention may employ an instruction for continuously loading multiple data and an instruction for continuously restoring multiple data, both unique to the processor, so as to process the digital signals by batch, and further enhance the operational performance.

### BRIEF DESCRIPTION OF THE DRAWINGS

The present invention will become more fully understood from the detailed description given herein below for illustration only, and thus are not limitative of the present invention, and wherein:

FIG. 1 is a flow chart of a conventional ZOH algorithm;

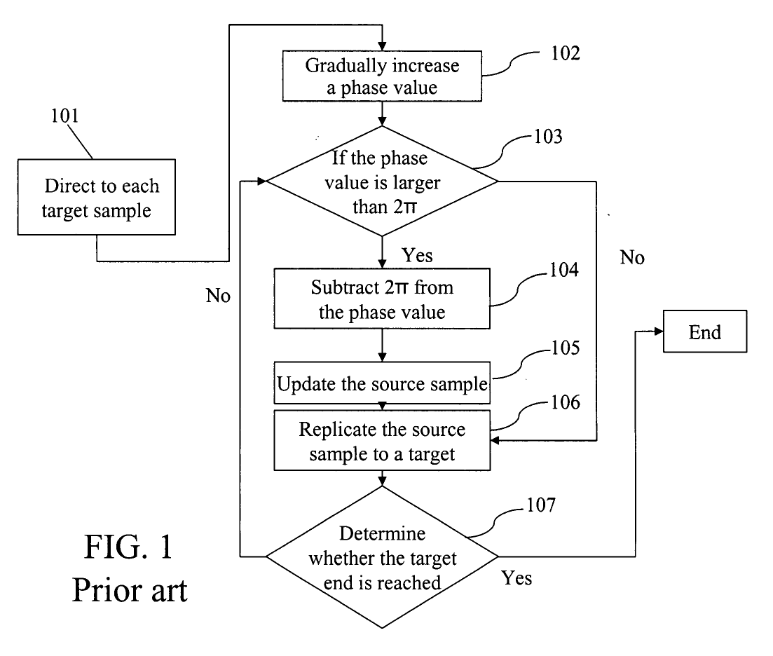

FIG. 2 is a schematic view illustrating an embodiment of the present invention;

FIG. 3 is a schematic view illustrating a sampling rate conversion sequence according to an embodiment of the present invention;

FIG. 4 is a flow chart of a digital signal conversion method according to an embodiment of the present invention; and

FIG. 5 is a flow chart of the loading/accessing processes in a digital signal conversion method according to an embodiment of the present invention.

### DETAILED DESCRIPTION OF THE INVENTION

The objective and method of the present invention are described in detail below with preferred embodiments, and the concept of the present invention may also be applied to other scopes. The embodiments below are only used to illustrate the objective and method of the present invention, instead of limiting the scope of the same.

In the following description of the present invention, “sampling rate conversion sequence” refers to a data set with corresponding relations, mainly for recording conversion ratios of data during the conversion of various audio/video digital signals at different sampling rates. Taking the audio conversion for example, in order to convert an audio data with a sampling rate of 8 kHz into one of 16 kHz, the audio data per unit has to be increased through replication. For the audio source, the proportion between the data amount that needs to be replicated for the audio amplification per unit and the original data is recorded in the sampling rate conversion sequence. In practice, the content of the sampling rate conversion sequence may be the corresponding relations of any two digital signal sampling rates, such as the combinations of converting from 8 kHz to 16 kHz, 8 kHz to 24 kHz, 8 kHz to 32 kHz, 8 kHz to 44 kHz, 16 kHz to 32 kHz, 16 kHz to 44 kHz, and 16 kHz to 64 kHz etc. In practice, the sampling rate conversion ratio may be recorded in the above sequence in any form and further stored in a data table, program code, or recording medium in a dispersive or concentrated manner.

In addition, according to the present invention, the ldmia instruction and stmia instruction, i.e., respectively an instruction for continuously loading multiple data and an instruction for continuously restoring multiple data, are unique to the ARM processor. The two instructions are mainly used for accessing continuous data, so as to accelerate the I/O processing speed. The above technique of accessing continuous data is apparent to those skilled in the art, and the details will not be given herein again.

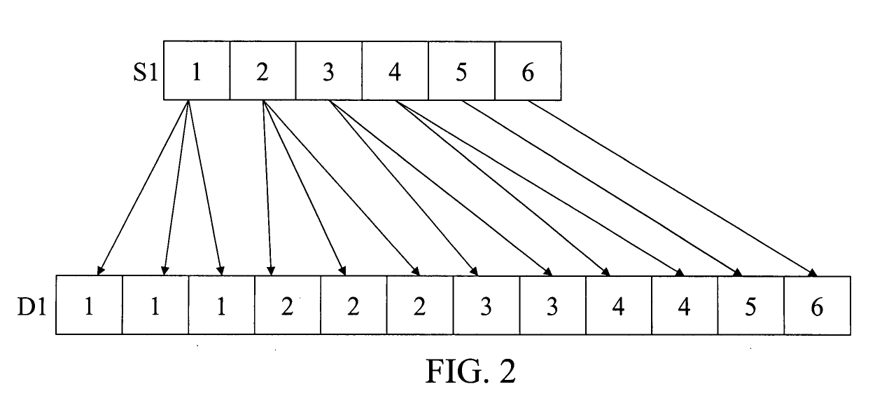

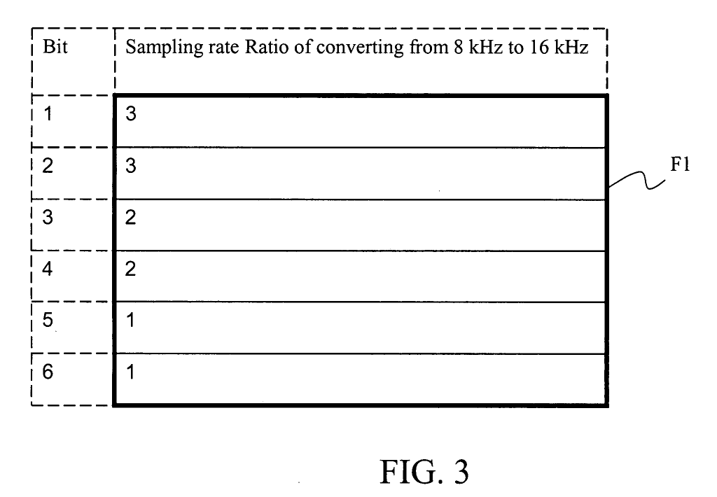

FIG. 2 is a schematic view illustrating an embodiment of the present invention, and FIG. 3 is a schematic view illustrating a sampling rate conversion sequence according to an embodiment of the present invention. Referring to FIGS. 2 and 3, a digital signal conversion system of the present invention is shown by embodiments. For the sake of simplicity, in this embodiment, converting an audio data with a sampling rate of 8 kHz into one of 16 kHz is taken as an example for illustrating audio conversion. In order to perform the audio sampling rate conversion, the electronic device loaded with the above conversion system first employs a reading means to read an audio source sample data, for example, an audio source sample data S1 in FIG. 2. In this embodiment, the sampling rate of the audio source sample data S1 is 8 kHz. A micro-processor of the electronic device replicates each audio sample according to the sampling rate conversion sequence of converting the sampling rate from 8 kHz to 16 kHz (for example, the sampling rate conversion sequence F1 in FIG. 3), and after the sampling rate conversion the micro-processor stores the replicated data into a memory to serve as the target data stream, for example, the target data stream D1 in FIG. 2.

In view of the above, in practice, the sampling rate conversion sequence may be generated by programs in advance, and the proportion of the number to be replicated for each source sample data is written in a program code beforehand. Thus, during the audio sampling rate conversion, there is no need to additionally calculate the phase value to determine the number of data copies, thus significantly reducing the operation load and reducing the operation time of the micro-processor. Moreover, if the said instructions is performing such as the ldmia or stmia instruction, the said instructions also performs accessing plenty of data. So the program execution speed will be accelerated. The ldmia and stmia instructions are unique to the ARM embedded system, and are not limited herein for the purpose of raising the data processing speed. With reference to this embodiment, those skilled in the art may design a program code generator for specific audio sampling ratios, so as to generate the sampling rate conversion sequence. It is apparent to those skilled in the art that the electronic device loaded with the system of the present invention may be any electronic apparatus with loudspeaker function, such as a cell-phone, personal digital assistant (PDA), digital photo frame, portable multimedia player (PMP), or MP3 player etc. These devices may convert the original audio data with a low sampling rate into one with a higher sampling rate, and play the converted audio data through a loudspeaker or store the obtained data in a new file. More particularly, compared with the conventional ZOH method, the method of the present invention reduces the floating-point operation time for calculating phase variations, and thus achieves a better performance. Additionally, in this embodiment, in order to describe the audio sampling conversion, the aforementioned digital signal conversion system and method thereof can be used to convert the data sampling ratio of video data, and the scope thereof is not limited herein. For example, in a digital camera system, the output video signal of a charge-coupled device (CCD) image sensor adopts an 18 MHz sampling. If it intends to lower the sampling rate to decrease the data transmission amount, Y, C-channel sampling rates of video images are respectively converted. This conversion method is similar to the above digital signal conversion method, and the details will not be described herein again.

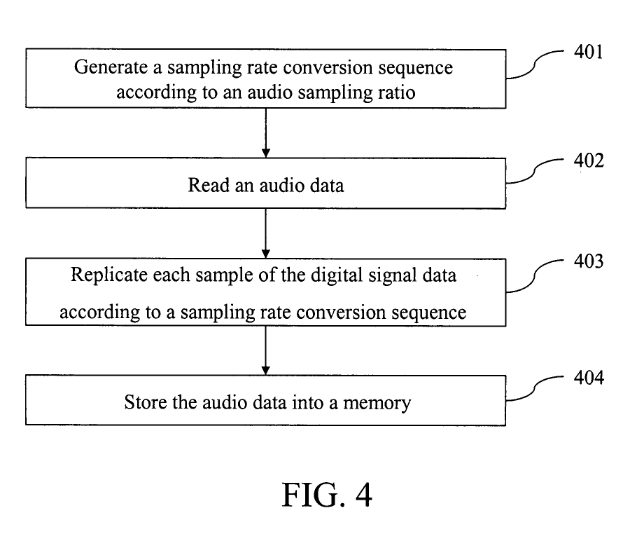

FIG. 4 is a flow chart of a digital signal conversion method according to an embodiment of the present invention. Referring to FIG. 4, the method includes the following steps. First, a sampling rate conversion sequence is generated according to an audio sampling ratio (Step 401). Then, an audio data is read (Step 402). Afterward, each sample of the audio data is replicated according to a sampling rate conversion sequence (Step 403). Finally, the audio data is stored into a memory (Step 404). In practice, the digital signal data adopted by the user may be any sampling rate. Therefore, sometimes, the electronic device may not be installed with a sampling rate conversion sequence applicable to the audio/video data, such that a suitable sampling rate conversion sequence can be generated by a built-in program, and serve as a data replication reference for the audio/video conversion.

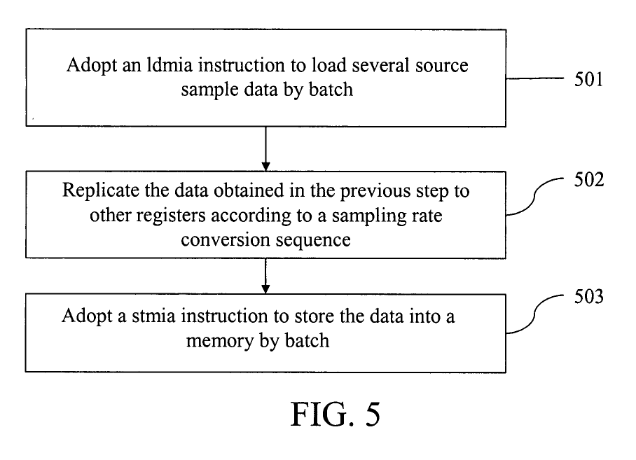

Accordingly, in practice, in order to accelerate the data access speed, the above embodiment is applied in an embedded system with an ARM architecture, and ldmia and stmia instructions may be adopted to further speed up the data access process. As shown in FIG. 5, when the electronic device carries out Step 501, the embedded system adopts the ldmia instruction to load several source sample data by batch. After that, Step 502 is performed to replicate the data obtained in the previous step to other registers according to a sampling rate conversion sequence. Then, Step 503 is performed to employ the stmia instruction to store the data into a memory by batch. Finally, Steps 501, 502, and 503 are repeated until the source sample data is converted into another sampling rate, and the program ends.

Seen from another aspect, the aforementioned device employing the digital signal conversion method may be a PC or house-hold appliance loaded with applications or an embedded hardware chip. Here, “device” is not a word used for limiting the appearance, size, or application of the physical apparatus applying the method. The device of the present invention includes a data reading unit for accessing a digital signal data and a sampling rate conversion sequence, for example, reading an audio data with a sampling rate of 16 kHz and a dedicated sampling rate conversion sequence with a sampling rate of 16 kHz, so as to convert the audio sampling rate from 16 kHz to 32 kHz or to any sampling rate. Further, the device may also include a data conversion unit for replicating the digital signal data into one with another sampling rate according to the sampling rate conversion sequence, and then storing the replicated data.

In view of the above, the device loaded with the system of the present invention may be a processing unit of an application or an embedded firmware. The processing unit may be a processor or chip in any form. Further, the device is installed with sufficient memory units and loaded with a sampling rate conversion sequence and digital signal data in advance, so as to store the digital signal data into a memory at different sampling rates after proper processing. In other words, this device is an electronic apparatus capable of performing digital signal sampling ratio conversion with high execution efficiency.

What is claimed is:

1. A digital signal conversion system, comprising:
a reading means, for reading a digital signal data;
a conversion means, for replicating a corresponding number of copies for each sample of the digital signal data according to a digital signal sampling conversion ratio recorded in a sampling rate conversion sequence, so as to convert the digital signal data; and
a storage means, for storing the replicated digital signal data into a memory.

2. The digital signal conversion system according to claim 1, wherein the digital signal data comprises audio/video data.

3. The digital signal conversion system according to claim 1, further comprising:
a sequence generation means, for generating the sampling rate conversion sequence according to the digital signal sampling conversion ratio.

4. The digital signal conversion system according to claim 3, wherein the digital signal sampling conversion ratio is a ratio of converting a sampling rate into another sampling rate, and the conversion ratio is stored in a data table, program code, or recording medium.

5. The digital signal conversion system according to claim 4 the reading means further comprising:
reading the digital signal data by batch.

6. The digital signal conversion system according to claim 5, wherein the reading means employs an instruction for continuously loading multiple data to read the digital signal data.

7. The digital signal conversion system according to claim 6, wherein the instruction for continuously loading multiple data is an ldmia instruction from an ARM processor.

8. The digital signal conversion system according to claim 4, the storage means further comprising:
storing the digital signal data by batch.

9. The digital signal conversion system according to claim 8, wherein the storage means employs an instruction for continuously restoring multiple data to store the digital signal data.

10. The digital signal conversion system according to claim 9, wherein the instruction for continuously restoring multiple data is a stmia instruction from the ARM processor.

11. A digital signal conversion method, comprising:
reading a digital signal data;
replicating a corresponding number of copies for each sample of the digital signal data according to a digital signal sampling conversion ratio recorded in a sampling rate conversion sequence, so as to convert the digital signal data; and
storing the replicated digital signal data into a memory.

12. The digital signal conversion method according to claim 11, further comprising:
generating the sampling rate conversion sequence according to the digital signal sampling conversion ratio.

13. The digital signal conversion method according to claim 12, wherein the sampling ratio is a ratio of converting a sampling rate into another sampling rate, and the conversion ratio is stored in a data table, program code, or recording medium.

14. The digital signal conversion method according to claim 13, the step of reading the digital signal data further comprising:
reading the digital signal data by batch.

15. The digital signal conversion method according to claim 14, wherein the step of reading the digital signal data by batch is employing an instruction for continuously loading multiple data to read the digital signal data.

16. The digital signal conversion method according to claim 15, wherein the instruction for continuously loading multiple data is an ldmia instruction from an ARM processor.

17. The digital signal conversion method according to claim 13, the step of storing the replicated digital signal data into the memory further comprising:
storing the digital signal data by batch.

18. The digital signal conversion method according to claim 17, wherein the step of storing the digital signal data by batch is employing an instruction for continuously restoring multiple data to store the digital signal data.

19. The digital signal conversion method according to claim 18, wherein the instruction for continuously restoring multiple data is a stmia instruction from the ARM processor.

20. A computer-readable recording medium for recording a computer executable program code for enabling a computer to provide a service of sample rate conversion, the service comprising the steps of:
reading a digital signal data;
replicating a corresponding number of copies for each sample of the digital signal data according to a digital signal sampling conversion ratio recorded in a sampling rate conversion sequence, so as to convert the digital signal data; and
storing the replicated digital signal data into a memory.

21. The computer-readable recording medium according to claim 20, further comprising:
generating the sampling rate conversion sequence according to the digital signal sampling conversion ratio.

22. The computer-readable recording medium according to claim 20, further comprising:
reading the digital signal data by batch.

23. The computer-readable recording medium according to claim 22, wherein the step of reading the digital signal data by batch is employing an instruction for continuously loading multiple data to read the digital signal data.

24. The computer-readable recording medium according to claim 23, wherein the instruction for continuously loading multiple data is an ldmia instruction from an ARM processor.

25. The computer-readable recording medium according to claim 21, further comprising:
storing the digital signal data by batch.

26. The computer-readable recording medium according to claim 25, wherein the step of storing the digital signal data by batch is employing an instruction for continuously restoring multiple data to store the digital signal data.

27. The computer-readable recording medium according to claim 26, wherein the instruction for continuously restoring multiple data is a stmia instruction from the ARM processor.
